(19) United States
(12) Patent Application Publication
(10) Pub. No.: US 2007/0031579 A1
(43) Pub. Date: Feb. 8, 2007

(54) Natural product flavor concentrates as liquid spices: formulation and dispensing

(76) Inventors: Nanine A. Van Draanen, San Luis Obispo, CA (US); Arlen Van Draanen, Bellevue, WA (US)

Correspondence Address: BEYER WEAVER & THOMAS, LLP, P.O. BOX 70250, OAKLAND, CA, 94612-0250, US

(21) Appl. No.: 11/497,910

(22) Filed: Aug. 1, 2006

Related U.S. Application Data
(60) Provisional application No. 60/705,963, filed on Aug. 4, 2005.

(51) Int. Cl. A23L 1/221

(52) U.S. Cl. 426/650

(57) ABSTRACT

The present invention describes a formulation and dispensing methodology for liquid spice that can be used as a volume-for-volume replacement for traditional herbs and spices with a flavor true to the fresh herb or spice. This formulation gives a product free of microbiological contamination without the need for chemical or radiation-based disinfection. The formulation uses a natural-product extraction of fresh or dried herbs or spices, diluted with carriers such as a nutritive oil, ethanol, propylene glycol, or water (or a combination or combinations of the above). The resulting solution can either be used as-is or filtered to provide optimum clarity. The resulting concentration of the flavor component in the carrier is standardized to provide a flavor comparable to a fresh or dried herb or spice. The present invention further provides for convenient delivery of the formulated liquid spice to displace traditional measuring practices.

### CROSS REFERENCE TO RELATED APPLICATIONS

This patent application claims the priority of U.S. Provisional Patent Application Ser. No. 60/705,963 entitled “NATURAL PRODUCT FLAVOR CONCENTRATES AS LIQUID SPICES: FORMULATION AND DISPENSING” filed Aug. 4, 2005, which is herein incorporated by reference.

### BACKGROUND OF THE INVENTION

1. Field of the Invention

The present invention relates generally to a method for the formulation and dispensing of liquid spice that can be used as a replacement for dry or fresh herbs and spices with a flavor true to the fresh herb or spice.

2. Description of the Related Art

Herbs and spices are commonly used in foods of all sorts. Herbs are generally defined as the aromatic leafy portions of edible plants (such as oregano, thyme, and tarragon) and spices are the non-leafy portions of edible plants, including seeds, bark, flowers, etc. Dried herbs and spices are a common substitute for their fresh equivalents. Dried spices, however, suffer from a few significant drawbacks to their use. First, the flavor of a dried spice is not identical to that of the fresh product. Some changes in the composition of the flavor components occur during the drying process. Second, the flavor is not instantly available, often requiring prolonged simmering times to release the flavor. In addition to the time involved, some flavors require different levels of heating to produce optimum flavors; for example, turmeric requires a higher heat than cumin to release its flavor. When cooked together, such as in commercial Indian curry powders, it often occurs that either the cumin ends up burned, or the turmeric remains bitter and undercooked. Neither result is desirable. Third, the texture of dried spices can be distinctly unpleasant, as in dried rosemary, which is very hard and brittle, and is optimally ground with a mortar and pestle prior to use.

One further drawback to the use of fresh or dried herbs and spices is the accurate measuring of these foodstuffs. A typical home chef will use measuring spoons to dispense the herbs or spices, but given the variable sizes and densities of the products, it is difficult to achieve a uniform delivery. It can also be problematic to fill the measuring spoon: either the spoon must fit into the jar containing the herb or spice, or the flavoring must be poured out into the measuring spoon. In the former case, many spice products come in jars too small to fit the larger measuring spoons, and in applications requiring multiple spices, there is a risk of contamination when using the same measuring spoon for more than one product. In the latter case, many spices simply do not pour well, resulting in spillage, which leads to waste and mess.

In addition to the drawbacks for the home chef in using dried spices, there are other, less generally familiar drawbacks to the use of dried spices. Spices, being an herbaceous product, are generally able to support the growth of microorganisms, and there are often growths of molds, fungi, and/or bacteria on the herb or spice. The presence of these microorganisms can result in potentially serious contamination, leading to food poisoning, especially when used in products that are not cooked thoroughly (as in salad dressings, dips, and marinades, to name a few). To circumvent this problem, herbs and spices are routinely treated to destroy the microorganisms. The three major methods for disinfection are treating the plant product with ethylene oxide gas, nuclear irradiation, or steam treatment. Each of these methods has significant drawbacks as discussed below.

Ethylene oxide (ETO) is a known carcinogen, and its use has been banned in many countries but is still allowed in North America. Ethylene oxide is extremely flammable and explosive upon mixture with air. This chemical reacts violently with many compounds. Short-term exposure can cause eye, skin, and respiratory tract irritation. Inhalation of high concentrations can cause lung edema, and exposure to the liquid form of the compound can cause frostbite. It may cause effects on the eyes, resulting in delayed development of cataracts. Long term or repeated exposure has been shown to cause cancer in humans and may cause heritable genetic damage in humans. The fumigation process requires a mixture of ETO and carbon dioxide to pass through the herbs and spices. A residue of ETO remains on the plant products and must be allowed to dissipate; therefore, the treated herbs and spices are left open to the air for a period of time, which allows the toxic ETO to be released into the air, clearly undesirable given the extreme toxicity of this compound. In addition, the exposure of the treated herbs and spices to the air can result in re-contamination of the foodstuff, especially with mold. The fumigation process itself is not always effective. The density of some spices, or the physical shape (such as wrinkles in peppercorn or twists in cinnamon bark), makes fumigation difficult: the gas cannot penetrate deeply into the dense, ground spice or into the nooks and crannies of the spices. Because of this limitation, the herbs and spices must be analyzed for microbial content, and if the batch fails the microbial test, the fumigation process must be repeated. Another safety concern with the use of ETO is that the chemical can react with molecules in the plant, resulting in chemical changes in the herb or spice. The result of these reactions can produce a change in flavor of the herb or spice and can also produce a toxic chemical byproduct, such as ethylene chlorohydrin, another known carcinogen. Finally, the use of ETO as a funigant can result in color and flavor changes in the herb or spice.

The second method of disinfection, nuclear irradiation, is a technology fraught with controversy and has very little consumer support. Nuclear irradiation of spices is accomplished using ionizing radiation including gamma rays, high-energy electrons, and x-rays. The average dose of radiation is 10 kiloGrays, or about 100 million times the dose received during a chest x-ray. Much of the public is fearful of all things nuclear, bringing to mind nuclear waste problems, nuclear weapons, and infamous accidents involving nuclear power plants. Given the choice, many people would prefer their food to be nuclear-irradiation free, even if it means a greater risk of food poisoning. In addition to the inherent risk and problems associated with the nuclear industry, nuclear irradiation of food may produce chemical changes in the food, called “radiolytic products” and the newly-produced chemicals may have unknown biological effects, including being toxic or carcinogenic. Irradiation is also reported to be able to change the flavor, odor, and texture of food.

The final method for decontamination that is used is steam processing of the herb or spice. There is some evidence that this method is less effective and re-contamination of the spice can occur. Additionally, treatment with steam can remove some of the volatile flavor component, resulting in a product with even less flavor than other dried herbs contain.

The use of fresh herbs and spices is not normally a practical solution to dispense with the undesirable characteristics of dried herbs and spices. Fresh herbs and spices have limited shelf life, are subject to spoilage, and are often unavailable in the quantities that would be necessary proximate to their point of consumption.

To circumvent these problems, for many years commercial food processors have used natural product flavor concentrates—such as oleoresins or essential oils—prepared from the flavor-containing plant component. These concentrates have the desired flavor components of the whole herb or spice but are generally incapable of sustaining microbial growth because they are carbohydrate-free. The oleoresins contain the fat-soluble components of the herb or spice, including the aroma and flavor components, along with the color and lipid components. Oleoresins are commercially available and are prepared industrially by extraction of the flavor-containing plant component. The essential oils contain primarily the aroma and flavor components and are largely free of the color and lipid molecules. Essential oils are also commercially available and are generally prepared by steam distillation of the flavor-containing plant component. These commercial flavor concentrates have generally been available only to commercial food processors because the flavor is so intensely concentrated that their use is only suitable for very large-scale food production. The oleoresins are generally many times more flavorful than a dried spice, making even one drop of oleoresin too much flavor for the average family meal. Essential oils have an even more concentrated flavor than oleoresins, making them even less suitable for home cooking. The commercial processes that yield these natural product flavor concentrates are optimized to yield the maximum flavor from the given herb or spice, meaning that the full, pure flavor of the plant product is obtained. These processes therefore circumvent the variable-heat problem discussed earlier. Furthermore, having been already extracted from the whole plant, the flavor is fully and instantly available, obviating the need for the long simmer times required when using whole or ground herbs and spices. In addition, because the processes by which oleoresins and/or essential oils are produced yield a product free of the carbohydrate fraction of the natural product, the resulting flavor concentrates are generally incapable of supporting microbial growth. Therefore, a food substance free of microbial contamination, and free of the risk of future contamination, can be obtained without the use of any of the disinfection methods described earlier.

Many forms of processed, ready-to-eat foods contain “natural flavoring” wherein the food producer has used a natural product flavor concentrate to impart a desired flavor; in general these commercial applications are not intended to be used as ingredients in subsequent food preparation. Rather, these foods are intended to undergo little or no home cooking (primarily heating) prior to eating. Very few references to the use of these flavor concentrates in home food preparation are available. In the aromatherapy literature, which mainly focuses on the use of essential oils for health care, there is occasional mention of using the oils in food preparation, generally with the warning that the oils are highly concentrated and easily over used. The few commercial products that focus on the flavor of the natural product food concentrate (rather than their use as a flavoring ingredient in a complex prepared food) are the “dipping oils” and “Watkins Liquid Spice.” Dipping oils are very dilute solutions of natural product food concentrates (generally essential oils) in edible oils (usually olive or grape seed oils) and are intended as a butter-substitute for bread. These products are designed to imitate herb-infused oils, and they are too weakly flavored to be used as replacements for herbs and spices. Watkins Liquid Spice is in fact not spice at all but formulations of onion and garlic (neither are an herb or spice) essential oils in grape seed oil, meant to mimic an infusion of fresh onion and garlic in that oil.

### SUMMARY OF THE INVENTION

The invention relates, in one embodiment, to a liquid spice formulation wherein an oleoresin is diluted with a carrier or blended carrier to a concentration between one-fifth and five-times the flavor concentration of a fresh herb or spice.

The invention relates, in another embodiment, to a liquid spice formulation wherein an essential oil is diluted with a carrier or blended carrier to a concentration between one-fifth and five-times the flavor concentration of a fresh herb or spice.

The invention relates, in another embodiment, to a liquid spice formulation wherein a natural product flavor concentrate other than an oleoresin or essential oil is diluted with a carrier or blended carrier to a concentration between one-fifth and five-times the flavor concentration of a fresh herb or spice.

The invention relates, in another embodiment, to a liquid spice formulation wherein an oleoresin is diluted with a carrier or blended carrier to a concentration between one-fifth and five-times the flavor concentration of a dried herb or spice.

The invention relates, in another embodiment, to a liquid spice formulation wherein an essential oil is diluted with a carrier or blended carrier to a concentration between one-fifth and five-times the flavor concentration of a dried herb or spice.

The invention relates, in another embodiment, to a liquid spice formulation wherein a natural product flavor concentrate other than an oleoresin or essential oil is diluted with a carrier or blended carrier to a concentration between one-fifth and five-times the flavor concentration of a dried herb or spice.

The invention relates, in another embodiment, to a liquid spice formulation wherein a blended natural product flavor concentrate is diluted with a carrier or blended carrier to a concentration between one-fifth and five-times the flavor concentration of a fresh herb or spice.

The invention relates, in another embodiment, to a liquid spice formulation wherein a blended natural product flavor concentrate is diluted with a carrier or blended carrier to a concentration between one-fifth and five-times the flavor concentration of a dried herb or spice.

The invention relates, in another embodiment, to a liquid spice formulation wherein a color level visually comparable to that of the fresh or dried herb or spice is attained through use of a blended natural product flavor concentrate and a carrier or blended carrier to achieve the desired color level. The flavor concentration of the resulting liquid spice formulation will be between one-fifth and five-times the flavor concentration of a fresh or dried herb or spice.

The invention relates, in another embodiment, to a method for the delivery of liquid spice. The method of delivery may for example be made via a mechanical dispensing pump, a mechanical aerosol spray system, a dual dispensing system, a shaker top, and/or a single-use dispensing system system.

### BRIEF DESCRIPTION OF THE DRAWINGS

The invention will be readily understood by the following detailed description in conjunction with the accompanying drawings, wherein like reference numerals designate like structural elements, and in which:

FIG. 1 illustrates a flow diagram for the preparation of liquid spice from a natural product flavor concentrate and a selected carrier, in accordance with one embodiment of the present invention.

### DETAILED DESCRIPTION OF THE INVENTION

It is an object of the present invention to provide a formulation and dispensing methodology for liquid spice that can be used as a volume-for-volume replacement for herbs and spices with a flavor true to the fresh herb or spice.

It is another object of the present invention to provide a formulation for liquid spice with a concentration between one-fifth and five-times the flavor concentration of a fresh or dried herb or spice.

It is another object of the invention to provide a formulation for liquid spice that gives a product free of microbiological contamination without the need for chemical or radiation-based disinfection.

It is another object of the invention to utilize natural-product extractions of fresh or dried herbs or spices diluted with carriers such as nutritive oils, ethanol, propylene glycol, glycerol, or water directly or in combination in the formulation of liquid spice.

It is another object of the invention to achieve a color level visually comparable to that of the fresh or dried herb or spice through the blending of natural product flavor concentrates and a carrier or blended carrier to achieve a desired color level.

It is another object of the invention to provide for the convenient dispensing of the formulated liquid spice to displace traditional measuring practices.

These and other objects of the invention are provided by a method for the formulation of liquid spice in which natural-product extractions of fresh or dried herbs or spices are diluted with a carrier that can be used as a replacement for herbs and spices with a flavor true to the fresh or dried herb or spice.

The foregoing has outlined some of the more pertinent objects of the present invention. These objects should be construed to be merely illustrative of some of the more prominent features and applications thereof. Other beneficial results can be attained by applying the disclosed invention in a different manner or modifying it as will be described. Accordingly, other objects and a fuller understanding of the invention may be had by referring to the following description of the invention.

While not to be construed as limiting, the terms used herein have the following definitions unless indicated otherwise.

“Natural product flavor concentrate(s)” includes edible oleoresins, essential oils, enfleurage, other water-insoluble or nearly water-insoluble plant concentrates, and/or water-soluble or nearly water-soluble plant concentrates isolated from leaves, buds, stems, bark, flowers, rhizomes, seeds, and/or roots of plants. The isolation can be accomplished using steam distillation, supercritical fluid extraction, solvent extraction, non-solvent extraction, chromatography, and/or direct pressing of the plant leaves, buds, stems, bark, flowers, rhizomes, seeds, and/or roots. The natural products include all edible flavor-containing plants for which a solid flavoring form is available, including but not limited to: allspice, anise, basil, bay, black pepper, caraway, cardamom, celery, chives, cilantro, cinnamon, clove, coriander, cumin, dill seed, dill weed, epazote, fennel, ginger, lavender, leeks, lemon peel, mace, marjoram, nutmeg, orange peel, oregano, paprika, parsley, peppers, rosemary, sage, shallots, tarragon, thyme, turmeric, and white pepper, and blends thereof.

“Blended natural product flavor concentrate(s)” includes blends of edible oleoresins, essential oils, enfleurage, other water-insoluble or nearly water-insoluble plant concentrates, and/or water-soluble or nearly water-soluble plant concentrates isolated from leaves, buds, stems, bark, flowers, rhizomes, seeds, and/or roots of plants. The isolation can be accomplished using steam distillation, supercritical fluid extraction, solvent extraction, non-solvent extraction, chromatography, and/or direct pressing of the plant leaves, buds, stems, bark, flowers, rhizomes, seeds, and/or roots. The natural products include all edible flavor-containing plants for which a solid flavoring form is available, including but not limited to: allspice, anise, basil, bay, black pepper, caraway, cardamom, celery, chives, cilantro, cinnamon, clove, coriander, cumin, dill seed, dill weed, epazote, fennel, ginger, lavender, leeks, lemon peel, mace, marjoram, nutmeg, orange peel, oregano, paprika, parsley, peppers, rosemary, sage, shallots, tarragon, thyme, turmeric, and white pepper and blends thereof.

“Carrier(s)” includes nutritive or non-nutritive liquid substances that can dissolve or suspend the natural product flavor concentrates. These carriers include nutritive oils, including but not limited to: avocado oil, canola (rapeseed) oil, coconut oil, corn oil, grape seed oil, hazelnut oil, olive oil, palm kernel oil, peanut oil, pistachio oil, sunflower oil, safflower oil, and walnut oil. The carriers can also include edible alcohols such as ethanol, glycerol, and/or propylene glycol. For water-soluble natural product flavor concentrates, water can be used as a carrier.

“Blended carrier(s)” includes any mixture of the aforementioned carriers. For example, two or more nutritive oils could be a blended carrier, or a mixture or nutritive oil and ethanol, or a mixture of nutritive oil and propylene glycol, or a mixture or ethanol and water, or a mixture of glycerol, ethanol, and water.

“Liquid spice(s)” includes formulations of natural product flavor concentrates and/or blended natural product flavor concentrates with a carrier or blended carriers in a concentration from one-fifth to five-times the flavor of a fresh and/or dried herb or spice. The preferred concentration is that which equals the flavor of either the fresh herb or the dried herb or spice. The liquid spice formulation can either be a homogeneous solution or a suspension requiring shaking prior to use. The liquid spice formulation can either be colorless or colored. The degree of desired color can be achieved by blending natural flavor concentrates containing color with those that are colorless or nearly colorless.

“Mechanical dispensing pump” includes any pumping system designed to deliver between 0.25 mL to 30 mL of liquid.

“Mechanical aerosol spray” includes any spraying system designed to deliver between 0.05 mL and 15 mL of liquid.

“Dual dispensing system” includes any combination spray and pump that can deliver either a liquid stream or an aerosolized spray of the product, in an amount between 0.05 mL and 30 mL.

“Shaker top” includes any flow-restriction device that limits the dispensing of a liquid to about a drop or two upon shaking the bottle upside down.

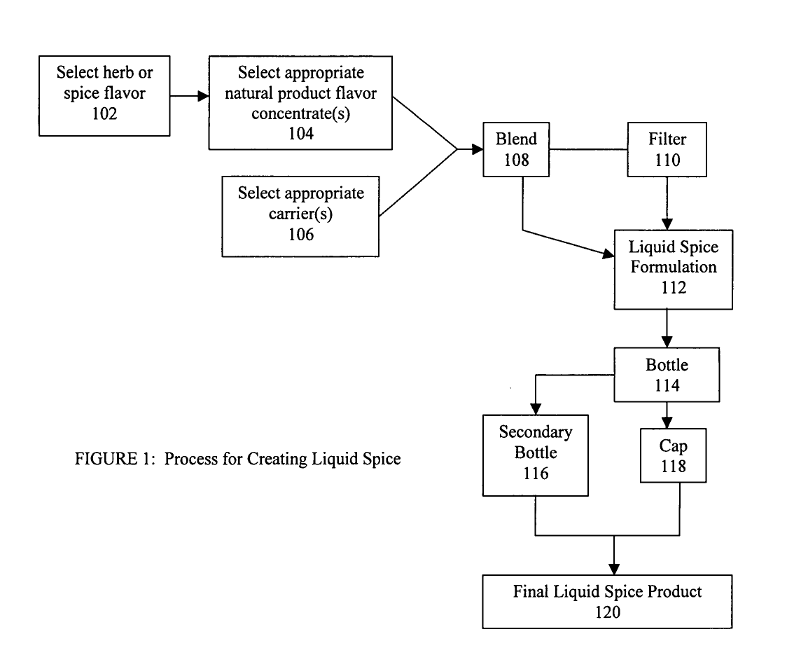

Referring now to FIG. 1, a process flow diagram for the preparation of liquid spice in accordance with one embodiment the invention is shown. Desired herb or spice flavor

is determined and the appropriate natural product flavor concentrate (NPFC), 104, is selected. Selection is based on the availability of the NPFC, the desired color, and flavor profile. In general, the oleoresin or water-soluble extractive is preferred over other NPFCs because of the more complete flavor profile. Occasionally, the oleoresin is too viscous or too intensely colored to make a desirable liquid spice. In these instances, a blend of essential oil and oleoresin is preferred. The quantity of NPFC is determined according to the strength of the desired flavor. Table 1 shows typical dilution factors.

Separately, carrier 106 is selected. Selection of the carrier is primarily based on the anticipated application of the resulting liquid spice. For most cooking needs, a nutritive oil is the desired carrier. For applications where the flavor will primarily be used in aqueous media, such as a flavoring for coffee or soup, a water-soluble carrier is preferred. The quantity of carrier is determined by the strength of the desired flavor. Table 1 shows typical ratios of NPFC to carrier for various flavor concentrates.

TABLE 1
Typical Dilution Ratios for the Preparation of Liquid Spice
Formulations with Flavor Concentrations Equivalent to Dried Spice

| | % Volatile | Parts | Parts |
|---|---|---|---|
| NPFC | Oil | NPFC | Carrier |
| Allspice Oleoresin | 30 | 1 | 30 |
| Cinnamon Oleoresin | 40 | 1 | 40 |
| Clove Oleoresin | 60 | 1 | 28 |
| Ginger Oleoresin | 40 | 1 | 30 |
| Nutmeg Oleoresin | 37 | 1 | 13 |
| Basil Oleoresin | 8 | 1 | 20 |
| Bay Oleoresin | 8 | 1 | 20 |
| Black Pepper Oleoresin | 21 | 1 | 30 |
| Cilantro Oleoresin | 7.1 | 1 | 20 |
| Coriander Oleoresin | 10 | 1 | 15 |
| Cumin Oleoresin | 30 | 1 | 25 |
| Fennel Oleoresin | 8 | 1 | 20 |
| Mace Oleoresin | 15 | 1 | 12 |
| Marjoram Oleoresin | 10 | 1 | 20 |
| Oregano Oleoresin | 30 | 1 | 20 |
| Rosemary Oleoresin | 4 | 1 | 25 |
| Sage Oleoresin | 35 | 1 | 20 |
| Tarragon Oleoresin | 15 | 1 | 20 |
| Thyme Oleoresin | 8 | 1 | 20 |
| Allspice Essential Oil | 100 | 1 | 100 |
| Clove Essential Oil | 100 | 1 | 100 |
| Nutmeg Essential Oil | 100 | 1 | 35 |
| Basil Essential Oil | 100 | 1 | 250 |
| Bay Essential Oil | 100 | 1 | 250 |
| Black Pepper Essential Oil | 100 | 1 | 143 |
| Cilantro Essential Oil | 100 | 1 | 282 |
| Coriander Essential Oil | 100 | 1 | 150 |
| Cumin Essential Oil | 100 | 1 | 83 |
| Fennel Essential Oil | 100 | 1 | 250 |
| Mace Essential Oil | 100 | 1 | 80 |
| Marjoram Essential Oil | 100 | 1 | 200 |
| Oregano Essential Oil | 100 | 1 | 67 |
| Rosemary Essential Oil | 100 | 1 | 625 |
| Sage Essential Oil | 100 | 1 | 57 |
| Tarragon Essential Oil | 100 | 1 | 133 |
| Thyme Essential Oil | 100 | 1 | 250 |
| Water-dispersible Allspice extract | 10 | 1 | 14 |
| Water-dispersible Cardamon extract | 40 | 1 | 15 |
| Water-dispersible Clove extract | 20 | 1 | 12 |
| Water-dispersible Ginger extract | 12 | 1 | 15 |
| Water-dispersible Nutmeg extract | 15 | 1 | 6 |
| Water-dispersible Cinnamon extract | 12 | 1 | 18 |

The NPFC 104 and carrier 106 are then blended in an appropriate vessel using mechanical agitation, shaking, or any other suitable mixing technique, to give blend 108. If particulate matter is present, mechanical filtration 110 is employed. If the blend 108 is homogeneous, filtration 110 is bypassed. Both processes yield the final liquid spice formulation 112, which is then bottled mechanically 114 in appropriately sized containers. The choice of container depends on the anticipated usage. For most home cooking applications, a convenient package size is a 2-to-4-ounce container. For use as a table seasoning, a 0.5-to-1-ounce container is appropriate. Other applications may warrant the use of a single-serving plastic package or an encapsulated single serving, giving 0.1 to 2 mL of the formulated liquid spice. In the latter cases, a secondary packaging (116) is required, which could be any convenient container to hold the single-serving packages.

The packaged product is then capped (118) with the dispensing system of choice. The choice of dispensing system again depends on the anticipated application. The formulated liquid spice can be capped with a simple lid to allow pouring the liquid, using an eyedropper to dispense, using a shaker-top, using a liquid-dispensing pump, or using an aerosol spray. For most home-cooking applications, a liquid-dispensing pump, aerosol spray, or dual dispensing system are preferred. For use as a table seasoning, a shaker top or aerosol spray are convenient dispensing methods.

The present invention solves all the problems associated with dry herbs and spices discussed in the Background herein. First, the use of natural product food concentrates obviates the need for a disinfection step in the preparation of the spice product. This allows for the product to be free of both irradiation and chemical fumigation. Secondly, since natural product food concentrates are prepared to optimize the flavor of the herb or spice, the desired flavor is always present and does not vary as between a fresh and dried herb. The flavor has all been released from the plant matrix in the preparation of the plant concentrate, meaning that the flavor is instantly available to the user and long simmering times are not required. Since the process to create the natural product flavor concentrate has been optimized for ultimate flavor, each flavor is completely available, solving the dual-heat problem discussed. Because the product is a homogeneous solution, the spice has no unpleasant texture.

In addition to the advantages discussed above, the liquid form of spice in the present invention allows for a much simpler and more uniform delivery method. The spice can be delivered by pouring the liquid or via a dropper, an aerosol spray, and/or a liquid pump. Having the spice in a liquid form confers several advantages, which solves the problems presented above. First, the spice has a uniform density, and being a liquid, the problem of variable particle size is eliminated. Secondly, measuring a liquid is generally simpler than measuring a solid: it pours well and fills a measuring spoon predictably. Thirdly, the product will always be dispensed from the packaging container into the measuring device, eliminating the risk of cross-contamination. Finally, use of a calibrated delivery system, such as a dropper, aerosol spray, and/or liquid pump ensures a neat and accurate dispensing of a pre-set amount of the liquid spice. Any of these pre-set delivery methods will provide optimum convenience, eliminating waste and mess. For very small amounts (less than 0.25 teaspoon or 1 mL), an aerosol spray is preferred; for the volumes normally encountered in recipes (0.25 teaspoon up to two tablespoons), a calibrated liquid pump is preferred.

### EXAMPLES

General methods: the “Modified Clevenger Method,” ASTA Analytical Method 5.0, determined volatile oil content. Natural product flavor concentrates were used as received from commercial suppliers. Carriers were used as received from commercial suppliers. Mixing vessels were made from glass, plastic, or stainless steel. Agitation was done by either magnetic stirring, overhead stirring, or shaking. Filtration was done either through glass wool or cotton or through Whatman filter paper using either standard gravity or vacuum filtration techniques.

### Example 1

### Liquid Allspice

To a mixing vessel containing 677 mL of canola oil was added 23 mL oleoresin of allspice isolated from Pimenta officinalis Lindl. containing 20.0-30.0% volatile oil. The resulting mixture was thoroughly agitated to yield a dark brown oily solution. The product can be used as-is, without filtration, as a volume-to-volume replacement for dried allspice.

### Example 2

### Liquid Basil

To a mixing vessel containing 2067 mL of sunflower oil was added 33 mL oleoresin of basil isolated from Ocimum basilicum L. containing 5.0-8.0% volatile oil. The resulting mixture was thoroughly agitated to yield a dark green oily solution. The product can be used as-is, without filtration, as a volume-to-volume replacement for fresh basil.

### Example 3

### Liquid Bay

To a mixing vessel containing 667 mL of grapeseed oil was added 33 mL of oleoresin of bay isolated from Laurus nobilis L. containing 4.0-8.0% volatile oil. The resulting mixture was thoroughly agitated to yield a dark, green oily solution. The product can be used as-is, without filtration, as a volume-to-volume replacement for fresh or dried bay leaves.

### Example 4

### Liquid Black Pepper

To a mixing vessel containing 670 mL of safflower oil was added 30 mL of oleoresin of black pepper isolated from Piper nigrum L. containing 17.0-21.0% volatile oil and 34.0-40.0% piperine. The resulting mixture was thoroughly agitated to yield a medium-green suspension. The product needs to be thoroughly shaken before use. It can be used as a volume-to-volume replacement for ground black pepper.

### Example 5

### Liquid Cilantro

To a mixing vessel containing 667 mL of olive oil was added 33 mL of cilantro oleoresin isolated from Coriandrum sativum L. containing 4.3-7.1% volatile oil. The resulting mixture was thoroughly agitated to yield a light yellow solution. The product can be used as-is, without filtration, as a volume-to-volume replacement for fresh cilantro leaves.

### Example 6

### Liquid Cinnamon

To a mixing vessel containing 450 mL of 95% ethanol and 243 mL of propylene glycol was added 17 mL of cinnamon oleoresin isolated from the inner bark of Cinnamomum zeylanicum, Cinnamomum loureirii, Cinnamomum cassia, and/or Cinnamomum burmanni. The oleoresin contained 25.0-40% volatile oil. The resulting mixture was thoroughly agitated to yield a medium-yellow solution. The product can be used as-is as a volume-to-volume replacement for dried cinnamon.

### Example 7

### Liquid Cloves

To a mixing vessel containing 322 mL of 95% ethanol was added 28 mL of clove oleoresin isolated from the dried buds of Eugenia cayophyllatea containing 40.0-60.0 volatile oil. The resulting mixture was thoroughly agitated to yield a colorless to light yellow solution. The product can be used as a two-to-one replacement for dried cloves.

### Example 8

### Liquid Coriander

To a mixing vessel containing 131 mL of propylene glycol was added 44 mL of coriander oleoresin isolated from Coriandrum sativum containing 6.0-10.0% volatile oil. The resulting mixture was thoroughly agitated to yield a colorless solution. The product can be used as a four-to-one replacement for dried, ground coriander seeds.

### Example 9

### Liquid Cumin

To a mixing vessel containing 692 mL of corn oil was added 8 mL of cumin essential oil isolated by steam distillation of the seeds of Cuminum cyminum. The resulting mixture was thoroughly agitated to yield a light yellow solution. The product can be used as a volume-to-volume replacement for dried, ground cumin.

### Example 10

### Liquid Fennel

To a mixing vessel containing 697 mL of avocado oil was added 3 mL of fennel essential oil isolated by steam distillation of the fruits of Foeniculum vulgare Mill. The resulting mixture was shaken thoroughly to yield a light yellow solution. The product can be used as a volume-to-volume replacement for dried, ground fennel seed.

### Example 11

### Liquid Ginger

To a mixing vessel containing 691 mL of peanut oil was added 9 mL of ginger essential oil isolated from the rhizomes of Zingiber officinale Rosc. The resulting mixture was agitated thoroughly to yield a light-yellow solution. The product can be used as a volume-for-volume replacement for fresh, chopped ginger root.

### Example 12

### Liquid Nutmeg

To a mixing vessel containing 681 mL of 95% ethanol was added 19 mL of nutmeg essential oil isolated by steam distillation of the seeds of Myristica fragrans Houtt. The resulting mixture was thoroughly mixed to yield a colorless to pale yellow solution. The product can be used as a volume-for-volume replacement for dried, ground nutmeg.

### Example 13

### Liquid Oregano

To a mixing vessel containing 500 mL of 95% ethanol and 190 mL of propylene glycol was added 10 mL of oregano essential oil isolated by steam distillation of the leaves and flowers of Origanum vulgare L.The resulting mixture was thoroughly agitated to yield a colorless to light reddish-yellow solution. The product can be used as a volume-for-volume replacement for dried oregano leaves.

### Example 14

### Liquid Rosemary

To a mixing vessel containing 696 mL of propylene glycol was added 4 mL of rosemary essential oil isolated by steam distillation of the leaves of Rosmarinus officinalis L. The resulting mixture was thoroughly agitated to yield a colorless solution. The product can be used as a four-to-one replacement for dried rosemary leaves.

Although certain examples have been used to illustrate and describe the present invention, it is intended that the scope of the invention not be limited to the specific examples set forth herein. Accordingly, the scope of the invention is intended to be defined only by the claims that follow, where such claims include certain terms defined herein.

What is claim is:

1. A liquid spice formulation wherein an oleoresin is diluted with a carrier or blended carrier to a concentration between one-fifth and five-times the flavor concentration of a herb or spice.

2. A liquid spice formulation as described in claim 1, wherein the concentration is between one-half and two-times the flavor concentration of a herb or spice.

3. A liquid spice formulation as described in claim 1, wherein the concentration is equivalent to the flavor concentration of a herb or spice.

4. A liquid spice formulation as described in claim 1, wherein the herb or spice is a fresh herb or spice.

5. A liquid spice formulation as described in claim 1, wherein the herb or spice is a dried herb or spice.

6. A liquid spice formulation wherein an essential oil is diluted with a carrier or blended carrier to a concentration between one-fifth and five-times the flavor concentration of a herb or spice.

7. A liquid spice formulation as described in claim 6, wherein the concentration is between one-half and two-times the flavor concentration of a herb or spice.

8. A liquid spice formulation as described in claim 6, wherein the concentration is equivalent to the flavor concentration of a herb or spice.

9. A liquid spice formulation as described in claim 6, wherein the herb or spice is a fresh herb or spice.

10. A liquid spice formulation as described in claim 6, wherein the herb or spice is a dried herb or spice.

11. A liquid spice formulation wherein a natural product flavor concentrate other than an oleoresin or essential oil is diluted with a carrier or blended carrier to a concentration between one-fifth and five-times the flavor concentration of a herb or spice.

12. A liquid spice formulation as described in claim 11, wherein the concentration is between one-half and two-times the flavor concentration of a herb or spice.

13. A liquid spice formulation as described in claim 11, wherein the concentration is equivalent to the flavor concentration of a herb or spice.

14. A liquid spice formulation as described in claim 11, wherein the herb or spice is a fresh herb or spice.

15. A liquid spice formulation as described in claim 11, wherein the herb or spice is a dried herb or spice.

16. A liquid spice formulation wherein a blended natural product flavor concentrate is diluted with a carrier or blended carrier to a concentration between one-fifth and five-times the flavor concentration of a herb or spice.

17. A liquid spice formulation as described in claim 16, wherein the concentration is between one-half and two-times the flavor concentration of a herb or spice.

18. A liquid spice formulation as described in claim 16, wherein the concentration is equivalent to the flavor concentration of a herb or spice.

19. A liquid spice formulation as described in claim 16, wherein the herb or spice is a fresh herb or spice.

20. A liquid spice formulation as described in claim 16, wherein the herb or spice is a dried herb or spice.

21. A liquid spice formulation wherein a color level visually comparable to that of the fresh or dried herb or spice is attained through use of a blended natural product flavor concentrate and a carrier or blended carrier to achieve the desired color level, a flavor concentration of the resulting liquid spice formulation being between one-fifth and five-times the flavor concentration of a herb or spice.

22. A liquid spice formulation as described in claim 21, wherein the concentration is equivalent to the flavor concentration of a herb or spice.

23. A liquid spice formulation as described in claim 21, wherein the concentration is between one-half and two-times the flavor concentration of a herb or spice.

24. A liquid spice formulation as described in claim 21, wherein the herb or spice is a fresh herb or spice.

25. A liquid spice formulation as described in claim 21, wherein the herb or spice is a dried herb or spice.

26. A method for the delivery of liquid spice via a mechanical dispensing pump; a mechanical aerosol spray system; a dual dispensing system; a shaker top system; or a single-use dispensing system.
